(19) United States
(12) Patent Application Publication
(10) Pub. No.: US 2010/0060789 A1
(43) Pub. Date: Mar. 11, 2010

(54) RECEPTION DEVICE AND RECEPTION METHOD

(75) Inventors: Hiroshi Aoki, Hiroshima (JP); Tsuneki Yasuho, Osaka (JP); Hidekazu Suzuki, Osaka (JP); Keisuke Iwata, Osaka (JP); Yasunobu Kanzaki, Hyogo (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/520,647

(22) PCT Filed: Aug. 22, 2008
(86) PCT No.: PCT/JP2008/002275

§ 371 Date: Jun. 22, 2009

(30) Foreign Application Priority Data
Aug. 24, 2007 (JP) 2007-217960

(51) Int. Cl. H04N 5/445; H04N 7/025

(52) U.S. Cl. 348/563; 725/33; 348/E05.099

(57) ABSTRACT

The display information generating unit manages a first plane that contains video information and a second plane that contains first still information and second still information, and merges the first plane and second plane. The control unit adds at least one of the first still information and second still information to the second plane when an interrupt signal is generated. If the display area of the video information is the full display area of the display screen, the control unit starts a screen saver operation that changes the first still information after a first predetermined period from a time point of the interrupt signal. If the display area of the video information is smaller than the full display area of the display screen, the control unit starts a screen saver operation that changes the second still information after a second predetermined period from a time point of the interrupt signal.

### BACKGROUND OF THE INVENTION

1. Field of Invention

The present invention relates to a reception device and a reception method for receiving cable television broadcasts, for example, and relates more particularly to a reception device and a reception method that are used in a flat panel display device such as a plasma display panel (PDP).

2. Description of Related Art

Conversion to digital broadcasts continues in the cable television industry, and a variety of services are now available. Various technologies have also been developed for the reception devices used to receive cable broadcasts. See, for example, U.S. Patent Application Publication No. 2004/0107451. One such technology is the Open Cable Application Platform (OCAP) that has been proposed as a standard specification for next-generation cable broadcasting services and devices in North America.

OCAP enables a cable broadcasting reception system including a television and set-top box, for example, to download an electronic program guide from the broadcaster, and to download specialized applications (JAVA (R) applications) for viewing video-on-demand (VOD) programming. The reception device implements a particular function by executing the downloaded application under the application program interface (API) defined in the OCAP specification. Applications thus conforming to the OCAP specification are referred to below as “OCAP applications.”

An OCAP application may display a fixed image containing text and graphics in all or a part of the television or monitor screen.

See, for example, U.S. Patent Application Publication No. 2004/0107451.

When an OCAP application window containing such a fixed image is displayed for an extended period of time on a plasma display panel, however, an image retention problem sometimes also referred to as image burn-in may occur.

This image retention problem is described next.

The plasma discharge state of a plasma display panel changes according to the brightness of the video signal to be displayed, and variation can result in a drop in luminance. Generally speaking, the brighter the video signal, the faster the luminance drop. In addition, when the displayed video is a fixed image containing text and graphic elements, a luminance difference occurs on the display and ghosts may occur when the displayed image changes.

### SUMMARY OF THE INVENTION

The present invention is directed to solving the foregoing problem, and a reception device and reception method according to the present invention prevent image burn-in when a fixed image containing text and graphic elements (also referred to as “still information” herein) is displayed on a plasma display panel.

A first aspect of the invention is a reception device that processes a reception signal and generates display information displayed on a display screen, the reception device including a display information generating unit that manages a first plane that can contain video information generated from the reception signal and a second plane that can contain first still information or second still information, generates the display information by merging the first plane and second plane, and outputs the display information to the display screen; an interrupt signal generating unit that generates an interrupt signal; and a control unit that controls the display information generating unit to generate and output to the display screen display information containing the first still information or second still information related to the interrupt signal in the second plane when an interrupt signal is input, starts a screen saver operation that changes the first still information after a first predetermined period if the display area of the video information is the full display area of the display screen, and starts a screen saver operation that changes the second still information after a second predetermined period if the display area of the video information is smaller than the full display area of the display screen.

A second aspect of the invention is a reception method for processing a reception signal and generating display information displayed on a display screen, the reception method including a step of managing a first plane that can contain video information generated from the reception signal and a second plane that can contain first still information or second still information, and generating the display information by merging the first plane and second plane; a step of generating an interrupt signal; and a step of controlling the step of generating the display information to generate and output to the display screen display information containing the first still information or second stilt information related to the interrupt signal in the second plane when an interrupt signal is input, starting a screen saver operation that changes the first still information after a first predetermined period if the display area of the video information is the full display area of the display screen, and starting a screen saver operation that changes the second still information after a second predetermined period if the display area of the video information is smaller than the full display area of the display screen.

A reception device and reception method according to the present invention prevent image burn-in when a fixed image containing text and graphic elements is displayed on a plasma display panel.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the hardware configuration of a reception device according to a first embodiment of the invention.

FIG. 2 is a block diagram showing the function configuration of a cable reception device according to the first embodiment of the invention.

FIG. 3 schematically describes the transitions between the OSD not-operating state, the OSD operating state, and the screen saver operating state.

FIG. 4 is a flow chart describing the flow of the screen saver operation in the first embodiment of the invention.

FIG. 5 schematically describes the screen saver operation in the first embodiment of the invention.

FIG. 6 schematically describes the screen saver operation in the first embodiment of the invention.

FIG. 7 schematically describes the screen saver operation in the first embodiment of the invention.

FIG. 8 schematically describes the screen saver operation in the first embodiment of the invention.

FIG. 9 schematically describes the screen saver operation in the second embodiment of the invention.

FIG. 10 schematically describes scaling the video display area in a fourth embodiment of the invention.

FIG. 11 is a flow chart describing the flow of the screen saver operation in the fourth embodiment of the invention.

FIG. 12 is a flow chart describing the flow of the screen saver operation in the fifth embodiment of the invention.

FIG. 13 schematically describes a fixed menu in a sixth embodiment of the invention.

FIG. 14 is a flow chart describing the flow of the screen saver operation in the sixth embodiment of the invention.

FIG. 15 is a flow chart describing the flow of the screen saver operation in the seventh embodiment of the invention.

FIG. 16 schematically describes state transitions in the screen saver process according to a seventh embodiment of the invention.

FIG. 17 shows an example of an MMI message screen according to an eighth embodiment of the invention.

FIG. 18 is a flow chart describing the flow of the screen saver operation in the eighth embodiment of the invention.

FIG. 19A schematically describes the movement process when the screen saver operation is interrupted in a ninth embodiment of the invention.

FIG. 19B schematically describes the movement process when the screen saver operation is interrupted in a ninth embodiment of the invention.

FIG. 20 is a flow chart describing the flow of the screen saver operation in the ninth embodiment of the invention.

FIG. 21 is a flow chart describing the flow of the OSD operation during EAS reception in a tenth embodiment of the invention.

FIG. 22 schematically shows an example of the OSD when a warning message is displayed during EAS reception in a tenth embodiment of the invention.

FIG. 23 is a flow chart describing the flow of screen saver operation during EAS reception in a tenth embodiment of the invention.

### KEY TO THE FIGURES

100 cable receiver
10 CPU
11 display
12 synthesis unit
13 plane management unit
14 AV decoder
15 TD decoder
16 tuner
17 cable card interface
18 remote control reception unit
19 hard disk drive
20 memory
21 cache memory
22 selector
23a processing circuit
23b processing circuit
23c processing circuit
200 broadcasting server
250 cable
300 cable card
400 remote control
51a internal application
51b internal application
52a OCAP application
52b OCAP application
53 internal application management unit
54 OCAP application management unit
55 operating mode management unit
56 key distribution unit
57 duplicated function management unit
58 data management unit
59 cable card management unit
60 OCAP version management unit
61 OCAP application storage unit
62 operating system
63 screen saver processing unit

### DETAILED DESCRIPTION OF THE PREFERRED EMBODIMENTS

Some preferred embodiments of the invention are described below with reference to the accompanying figures wherein parts having the same configuration, operation, and effect are denoted by the same reference numbers. Numbers used in the following description are by way of example only to describe the invention clearly, and the invention is not limited to these numbers in any way. Connections between specific elements and components are also shown by way of example only, and the connections achieving the function of the invention are not so limited. The following embodiments are also constituted using hardware and software components, but the hardware configurations can be constituted using software and the software configurations can be constituted using hardware.

### Embodiment 1

A reception device according to a first embodiment of the invention prevents image retention or burn-in on a plasma display panel (PDP) by using a screen saver. A first novel aspect of this first embodiment of the invention relates to the configuration that starts the screen saver operation, and second novel aspect of the invention relates to implementing this screen saver function.

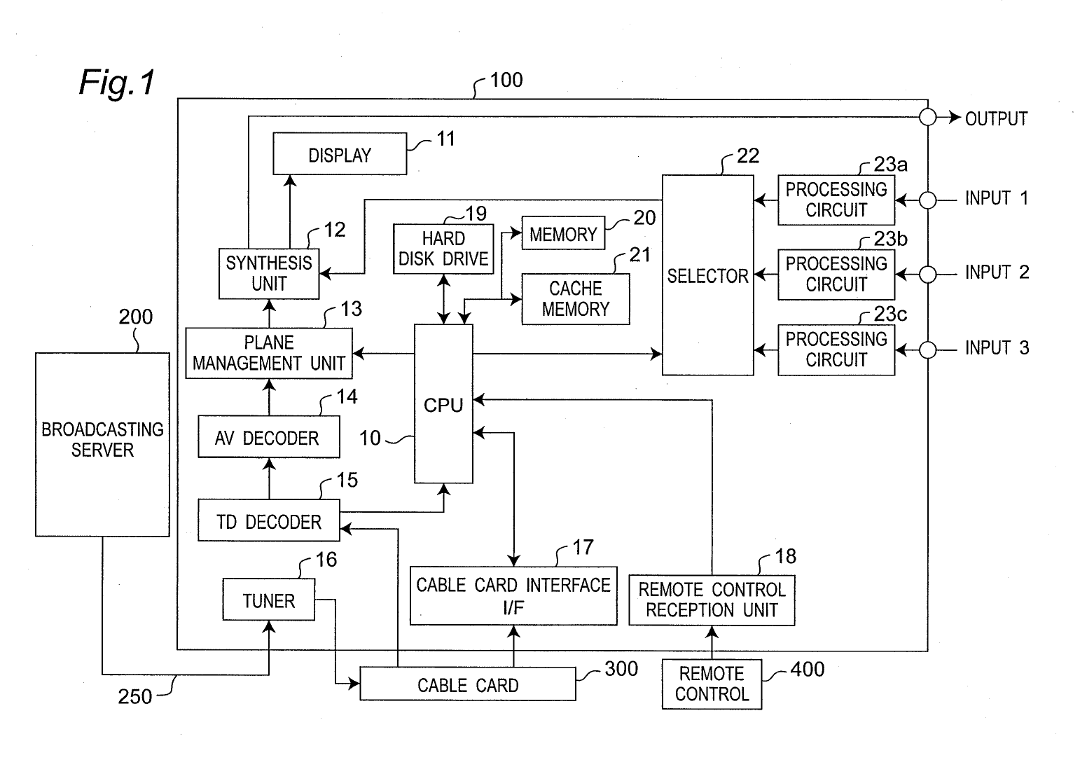

FIG. 1 is a block diagram schematically showing the hardware configuration of a reception device according to this first embodiment of the invention.

Referring to FIG. 1, a broadcasting server 200 is located in a broadcasting station of the cable company, and delivers cable broadcasts through a cable 250 to individual subscribers (cable broadcast receivers).

A cable receiver 100 is installed in the home, for example, of each subscriber, and receives cable broadcasts from a particular cable company (broadcaster) through the cable 250 when a particular process is executed using an inserted cable card 300. The cable receiver 100 also receives user operation information (key code values) through a remote control 400, and executes processes identified by a received key code. The cable receiver 100 has an output channel (output) and a plurality of input channels (input 1, input 2, input 3) in this embodiment of the invention. The cable receiver 100 outputs audio/video signals to an external recording device such as a DVD (Digital Versatile Disc) recorder through the output channel. A plurality of AV signals can be input from sources other than the cable broadcasting company to the cable receiver 100 through the input channels. The cable receiver 100 according to this embodiment of the invention can receive cable transmissions conforming to the OCAP (Open Cable Application Program) standard.

The remote control 400 is also referred to as an external input unit.

Note that the configuration used to process audio signals is omitted in FIG. 1 for brevity.

The cable receiver 100 has a CPU 10 (central processing unit), display 11, synthesis unit 12, plane management unit 13, AV (Audio Video) decoder 14, TD (Transport Decoder) decoder 15, tuner 16, cable card interface 17, remote control reception unit 18, hard disk drive 19, memory 20, cache memory 21, a selector 22, and processing circuits 23a, 23b, and 23c.

The plane management unit 13 and synthesis unit 12 constitute an image information generating unit.

The CPU 10, hard disk drive 19, memory 20, and cache memory 21 constitute a control unit.

Each of the three function blocks described below, which constitutes the cable receiver 100, includes a function for generating an interrupt signal, and is therefore also referred to as an interrupt signal generating unit. The first of these function blocks is the remote control reception unit 18. The second is the cable card interface 17. The third is the function block including the TD decoder 15 and AV decoder 14. The interrupt signal generating unit generates an interrupt signal. A specific example of the interrupt signal is described below.

In this embodiment of the invention the display 11 is a plasma display panel, but the invention is not limited to being used with a plasma display panel and more specifically can also be applied to other types of display devices.

The cable card interface 17 detects when the cable card 300 is inserted and removed, and receives and outputs card information from the cable card 300 to the CPU 10. The card information includes one of the interrupt signals.

The remote control reception unit 18 receives and outputs user operating information (key code information) from the remote control 400 to the CPU 10. The user operating information (key code information) includes one of the interrupt signals.

The CPU 10 is a controller that controls operation of the cable receiver 100. The hard disk drive 19, memory 20, and cache memory 21 are connected to the CPU 10. The hard disk drive 19 is a data storage device. The memory 20 is a volatile storage device. The cache memory 21 is a nonvolatile storage device. The CPU 10 also displays content from any one of the cable broadcast and inputs 1 to 3 on the display 11 based on the key code information input to the remote control reception unit 18.

The tuner 16 receives a cable broadcast signal distributed from the broadcasting server 200 over the cable 250.

The cable card 300 descrambles and converts the received broadcast signal (that is, the reception signal) to a transport stream, and outputs the transport stream to the TD decoder 15.

The TD decoder 15 filters the transport stream and extracts the audio data, video data, and auxiliary data.

The AV decoder 14 decodes the audio data and video data compressed according to an MPEG (Motion Picture Experts Group) format into the audio information and video information, respectively. The auxiliary data is sent to the CPU 10. The auxiliary data includes one of the interrupt signals.

The CPU 10 also decodes the auxiliary data to auxiliary information.

The plane management unit 13 forms, manages, and outputs to the synthesis unit 12 a plurality of planes based on the video information and auxiliary information. Each of the plural planes contains the pixel data for one screen and is stored in a separate memory area. These plural planes include an internal application plane, a video plane, a still plane, and an OSD (on-screen display) plane.

The internal application plane is a plane that can contain OSD information and other still information (further described below) related to the internal application.

The video plane is a plane that can contain video information.

The still plane is a plane that can contain a still picture that is OCAP application uses as a background image.

The OSD plane is a plane that can contain primarily still images used by the OCAP application.

A dedicated OCAP application plane may also be provided. This dedicated OCAP application plane is a plane that can contain still information that the OCAP application does not want to output to the external recording device.

The processing circuits 23a, 23b, and 23c process and output the AV signals input from the respective input channels (input 1, input 2, input 3) to the selector 22.

The selector 22 selects one output from among the outputs from the processing circuits 23a, 23b, and 23c based on a command from the CPU 10, and outputs to the synthesis unit 12.

The synthesis unit 12 applies a reduction process, enlargement process, or movement process as necessary to the plural planes output from the plane management unit 13.

The synthesis unit 12 also applies a brightness reduction process, contrast reduction process, fixed image movement process, fixed image border movement process, or transparency adjustment process to the OSD plane as necessary.

The synthesis unit 12 merges the OSD plane, internal application plane, video plane, and still plane in this order from front to back as seen from the user according to the operating state of the internal application and OCAP application to generate display information representing the continuous merged image, and outputs to the display 11.

The synthesis unit 12 also merges the OSD plane, video plane, and still plane in this order from front to back as seen from the user to generate and output screen information to the external recording device.

The synthesis unit 12 may alternatively output the AV signal from the selector 22 instead of the foregoing display information to the display 11 and external recording device as needed.

The display 11 then presents the display information output from the synthesis unit 12 on the screen.

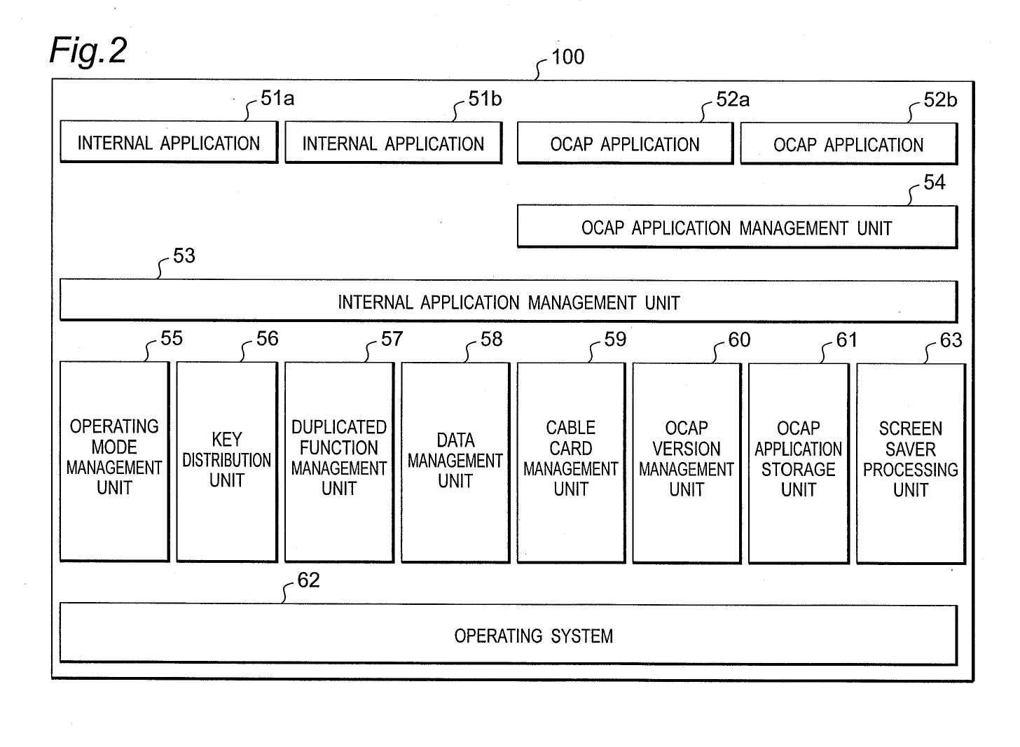

The functional configuration of the cable receiver 100 is described next with reference to FIG. 2. The functional configuration shown in FIG. 2 is rendered by the CPU 10 executing a specific program. Note that only important functions are shown in FIG. 2 for brevity. The functions of the cable receiver 100 described below are rendered by the CPU 10 executing a specific program even of those functions are not shown in FIG. 2.

The cable receiver 100 includes internal applications 51a and 51b, OCAP applications 52a and 52b, a internal application management unit 53, an OCAP application management unit 54, an operating mode management unit 55, a key distribution unit 56, a duplicated function management unit 57, a data management unit 58, a cable card management unit 59, an OCAP version management unit 60, an OCAP application storage unit 61, a screen saver processing unit 63, and an operating system 62.

The internal applications 51a and 51b include factory-installed applications and/or applications that are installed over a network or from a storage medium such as an SD card, such as a channel selection application, a parental controls display application, and a set-up application.

The OCAP applications 52a and 52b are applications that are downloaded and acquired from the broadcasting server 200, such as a channel selection application, a parental controls display application, and a set-up application.

The internal application management unit 53 controls starting the internal applications 51a and 51b and key distribution, and controls activating the OCAP application management unit 54.

The OCAP application management unit 54 is middleware for executing the OCAP applications 52a and 52b, and has the following four functions: (1) activating the OCAP applications 52a and 52b; (2) controlling distributing the key code information sent form the key distribution unit 56 to the OCAP applications 52a and 52b; (3) timer event control sending timer events to the OCAP applications 52a and 52b based on requests from the OCAP applications 52a and 52b; and (4) controlling reducing or moving the video area in the video plane, and controlling the allocation of pixels to the OSD plane, by controlling at least one of the synthesis unit 12 and plane management unit 13. In addition, the OCAP application management unit 54 controls starting and stopping the screen saver processing unit 63, and manages whether the screen saver is operating or not operating.

The operating mode management unit 55 manages the operating mode of the cable receiver 100. The operating modes include an IDTV (Improved Definition TeleVision) mode and OCAP mode. The IDTV mode is a state in which only the internal applications 51a and 51b operate. The OCAP mode is a state in which the OCAP applications 52a and 52b also operate.

The operating mode management unit 55 also manages the operating status of the internal applications 51a and 51b, and manages starting and stopping the OCAP applications 52a and 52b reported by the OCAP application management unit 54.

The key distribution unit 56 sends the key code information from the remote control 400 to the internal application management unit 53 or OCAP application management unit 54.

Based on predefined exclusive/shared information, the duplicated function management unit 57 determines the exclusive/shared status of the internal applications 51a and 51b and OCAP applications 52a and 52b. This exclusive/shared information is information denoting for each identical function that is executed by both applications whether the internal application 51a, 51b or OCAP application 52a, 52b takes priority.

The data management unit 58 manages data that is shared by the internal applications 51a and 51b and OCAP applications 52a and 52b, such as PIN (Personal Identification Number) information (that is, management information that uniquely identifies an individual), parental control information, and captioning or subtitling information.

The cable card management unit 59 receives, manages, and executes requests from the cable card 300.

The OCAP version management unit 60 manages the versions of the OCAP applications 52a and 52b stored in the OCAP application storage unit 61. The OCAP version management unit 60 also manages upgrading the OCAP applications 52a and 52b based on the received Extended Application Information Table (XAIT).

The XAIT is management information for the OCAP applications 52a and 52b sent from the broadcasting server 200, and includes at least version information for the activated OCAP applications 52a and 52b and the address (such as a URL) of the OCAP applications 52a and 52b on the broadcasting server 200. The cable receiver 100 regularly receives the XAIT from the broadcasting server 200.

The OCAP application storage unit 61 stores the OCAP applications 52a and 52b downloaded from the broadcasting server 200 based on the XAIT.

The screen saver processing unit 63 processes screen saver operation, and executes the screen saver operating state indicating that the screen saver is operating from the start of screen saver operation until the screen saver is stopped. The screen saver processing unit 63 tells the plane management unit 13 whether to apply the brightness reduction process, contrast reduction process, fixed image movement process, fixed image border movement process, or transparency adjustment process to the OSD plane.

The operating system 62 is a basic software program for managing overall operation of the cable receiver 100.

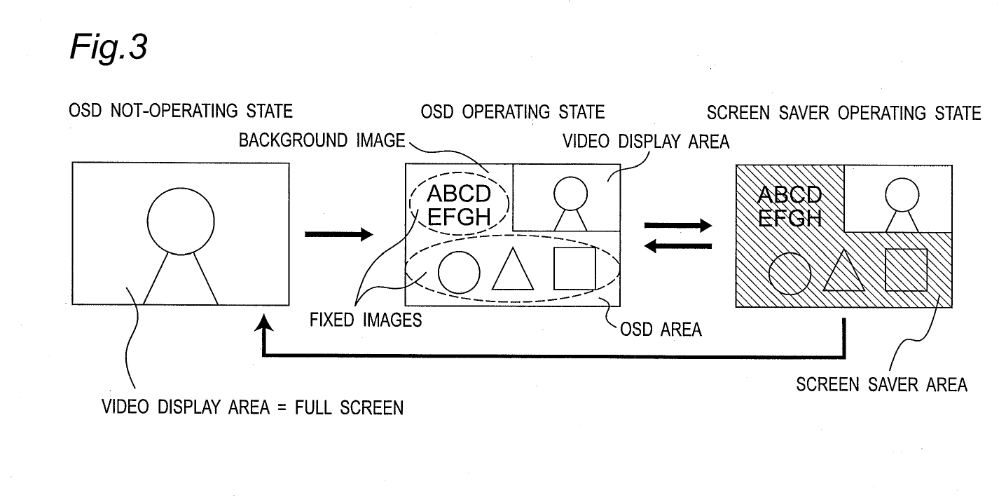

The screen saver operation is described briefly below with reference to FIG. 3. The screen shown on the left side in FIG. 3 shows the OSD not-operating state (also called the OSD no-draw state) in which an application window containing a fixed image is not displayed. The video display area, which is the screen area in which the program content or other video information is presented, occupies the entire screen when in the OSD not-operating state. The OCAP applications 52a and 52b are active in the OSD not-operating state, but all pixels on the OSD plane are transparent.

The screen shown in the middle in FIG. 3 illustrates the OSD operating state (also called the OSD draw state). The OSD operating state is a state in which some number of pixels in the OSD plane are not transparent. The OSD plane, which is an L-shaped application window containing a fixed image, is output from the plane management unit 13, merged by the synthesis unit 12 with the video plane containing the video display area, and then presented on the display 11. A scaled (reduced) video display area is written to the top right part of the screen shown in the middle. The L-shaped area outside of the video display area is called the OSD area (also called the OSD drawing area or OSD operating area).

The OSD area is always displayed and the video display area is smaller than the total screen area when in the OSD operating state.

Alternatively, the OSD area may occupy the entire screen and the video display area may be omitted in the OSD operating state.

The information displayed in the OSD area is primarily information that is used by an OCAP application, and is mainly information related to the video content. The information displayed in this OSD area is called “non-superimposed still information” because it is not superimposed on the video display area and is fixed, or not moving, on the screen. This information is also referred to as “OSD information.” This non-superimposed still information may be, for example, an electronic program guide, subtitles, information about players and other people that appear during live sports broadcasts, or a user input interface for interactive programming, and this non-superimposed still information is sent to the cable receiver 100 as auxiliary data. This non-superimposed still information is displayed as a fixed image of text and graphics, for example, presented at a constant size and position on screen. The OSD operating state is also referred to as a non-superimposed still information operating state.

A specific example of changing from the OSD not-operating state to the OSD operating state is described next with reference to FIG. 2.

The OCAP applications 52a and 52b perform at least one of the operations of reducing the video display area, moving the video display area, and distributing non-transparent pixels on the OSD plane when triggered by some event. Such triggers include user input from the remote control, timer events, and the OCAP application management unit 54 calling the startXlet method when an OCAP application 52a, 52b starts.

Triggers resulting from user operation of the remote control cause key code information corresponding to the key of the remote control 400 that was operated to be sent to the OCAP application 52a, 52b through the operating system 62, key distribution unit 56, and OCAP application management unit 54.

Timer events are reported by the OCAP application management unit 54 to the OCAP application 52a, 52b after a predetermined period has passed as a result of a request sent by an OCAP application 52a, 52b to the OCAP application management unit 54.

The OCAP application management unit 54 calls the startXlet method of the OCAP application 52a, 52b based on the OCAP specification.

In response to a request from an OCAP application 52a, 52b, the OCAP application management unit 54 controls at least one of the synthesis unit 12 and plane management unit 13 to execute at least one of the actions of reducing the video display area, moving the video display area, and writing pixels to the OSD plane.

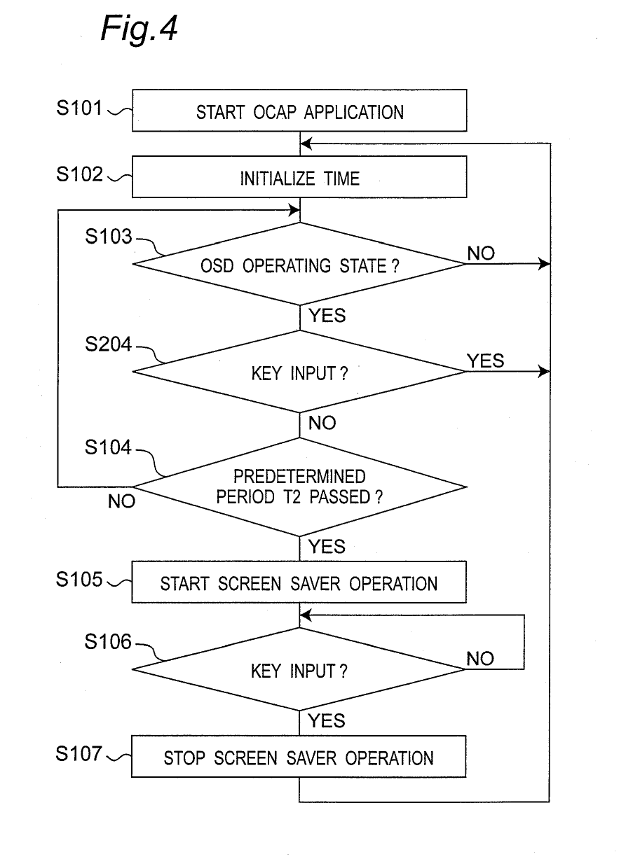

The configuration of the screen saver operation that is an important aspect of this embodiment of the invention is described next. FIG. 4 shows the flow of the screen saver operation in the first embodiment of the invention. The screen saver operation is described next with reference to FIG. 4.

In step S101 the OCAP application management unit 54 starts an OCAP application 52a, 52b. The operation of starting the application is described in detail below.

When the XAIT is received through the operating system 62, the cable card management unit 59 informs the internal application management unit 53 that the XAIT was received and sends the XAIT to the OCAP version management unit 60. The internal application management unit 53 activates the OCAP application management unit 54 upon receiving the XAIT reception report.

The OCAP application management unit 54 causes the OCAP version management unit 60 to compare the received XAIT with the previously stored XAIT. Based on the result of this comparison, the OCAP application management unit 54 starts an OCAP application 51a, 52b that is stored in the OCAP application storage unit 61.

In step S102 the OCAP application management unit 54 initializes the time in order to measure a predetermined period T2 (also referred to as the waiting period) further described below. More specifically, the OCAP application management unit 54 initializes a timer in the CPU 10 shown in FIG. 1 for counting the predetermined period T2.

In step S103, the OCAP application management unit 54 determines if the OSD operating state is active. If the OSD operating state is active control goes to step S204. If the OSD operating state is not active, control returns to step S102. The OSD operating state is entered by the OCAP application 52a, 52b asserting a command for writing to the OSD plane. This transition operation is described in further detail below.

When an appropriate trigger is received, the OCAP application 52a, 52b writes non-transparent pixels to the OSD plane through the OCAP application management unit 54 and plane management unit 13. Such triggers include user input from the remote control, timer events, and the OCAP application management unit calling the startXlet method when an OCAP application starts.

In step S204 the OCAP application management unit 54 determines if key input from the remote control 400 was detected (that is, if key code information was input). If key input is not detected, control goes to step S104. If key input is detected, control returns to step S102. Detecting key input is described below.

Determining if there was key input determines whether or not key code information corresponding to a key operated by the user on the remote control 400 was sent from the key distribution unit 56.

In step S104 the OCAP application management unit 54 determines through the operating system 62 whether predetermined period T2 has passed in a single OSD operating state. If this predetermined period T2 has passed, control goes to step S105. If the predetermined period T2 has not passed, control returns to step S103.

In step S105 the OCAP application management unit 54 starts the screen saver operation (that is, starts the screen saver) by starting the screen saver processing unit 63, and enters the screen saver operating state. The screen saver operating state is shown in the screen on the right side in FIG. 3. The screen saver operates in the screen saver area that is coincident to the OSD area. The screen saver is described in detail below.

In step S106 the OCAP application management unit 54 determines if there was key input from the remote control 400. If there was no key input, control returns to step S106 to continue the screen saver operating state. If key input is detected, control goes to step S107.

In step S107 the OCAP application management unit 54 stops the screen saver operation (that is, cancels the screen saver) by stopping the screen saver processing unit 63, which is in the screen saver operating state, and then returns to step S102. If the OCAP application management unit 54 is not in the screen saver operating state, it is in the screen saver not-operating state, indicating that the screen saver is not operating.

The predetermined period T2 referenced in step S104 may be preset at the factory prior to shipping the reception device, or it may be set by the user using a graphical user interface (GUI) not shown.

If key input is not detected in step S204 and the predetermined period T2 has not passed in step S104, the OCAP application management unit 54 repeats the idling loop of steps S103, S204, and S104. The state in which this idling loop repeats in the screen saver not-operating state (the OSD operating state in the first embodiment of the invention) is called the “no-screen-saver idling state.”

If key input is not detected in step S106, the OCAP application management unit 54 idles while repeating step S106. The state in which this idling process repeats in the screen saver operating state is called the “screen saver idling state.”

If an interrupt signal is asserted (that is, key input is detected) in the no-screen-saver idling state or screen saver idling state, the OCAP application management unit 54 stops idling. The OCAP application management unit 54 then initializes the time in step S102 and enters the screen saver operating state when step S104 determines that the predetermined period T2 has passed since a time related to generating the interrupt signal.

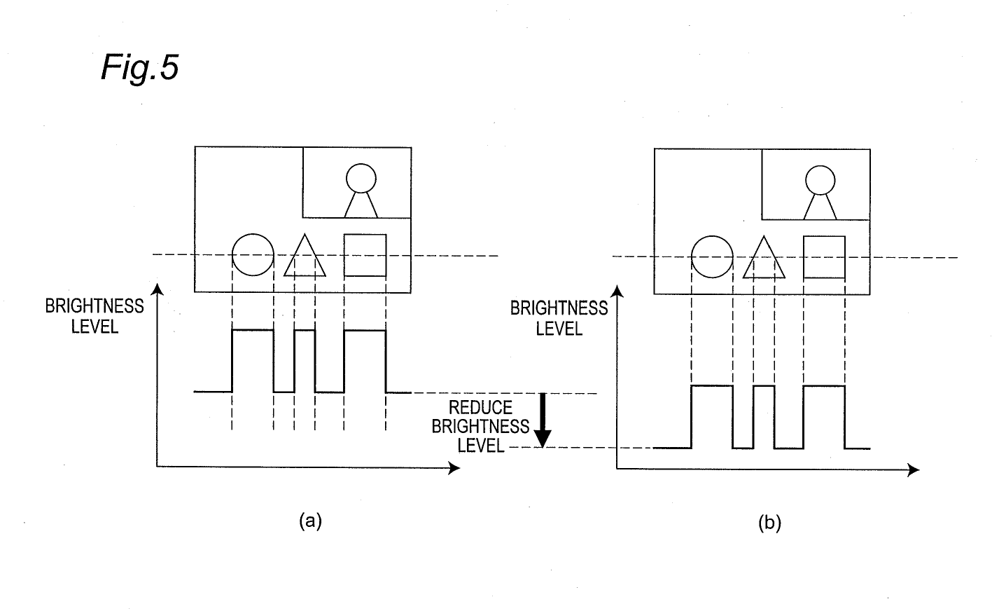

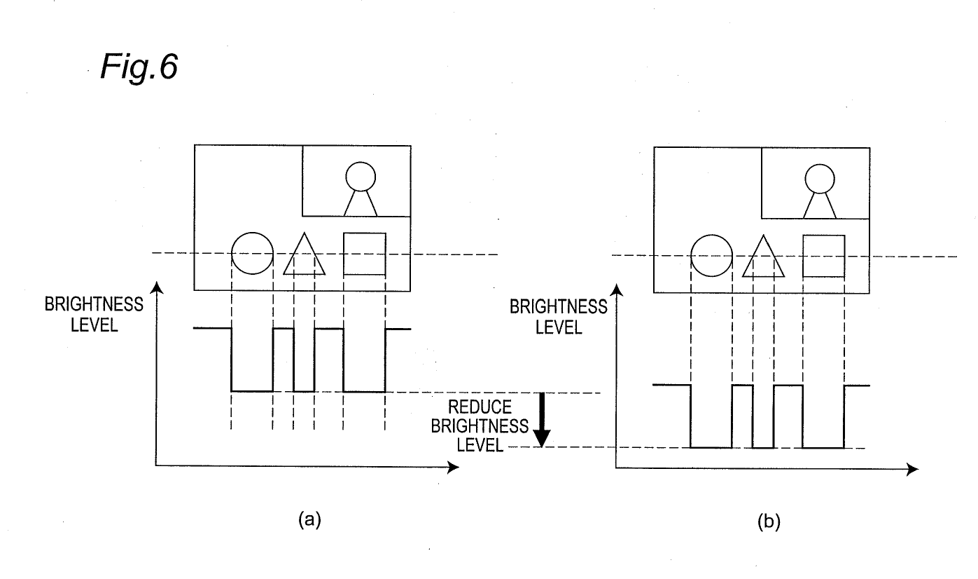

How the screen saver prevents image retention (burn-in) is described next In this first embodiment of the invention, the brightness of fixed images containing text and graphics, for example, is reduced in the screen saver operating state. FIG. 5(a) shows the state in which the screen saver is not operating, that is, the screen saver not-operating state, and FIG. 5(b) shows the screen saver operating state, in the OSD operating state. As shown in the figure, the brightness of the background image and the brightness of the graphic or other fixed image is reduced overall by a predetermined amount. This drop in brightness may be preset at the factory prior to shipping the reception device, or it may be set by the user using a GUI not shown.

Note that FIG. 5 shows an example in which the brightness of the displayed graphic is reduced, but the brightness of displayed text is reduced in the same way.

FIG. 5 shows an example in which the brightness of the fixed image is higher than the brightness of the background image, but the same explanation applies when the brightness of the fixed image is lower than the brightness of the background image.

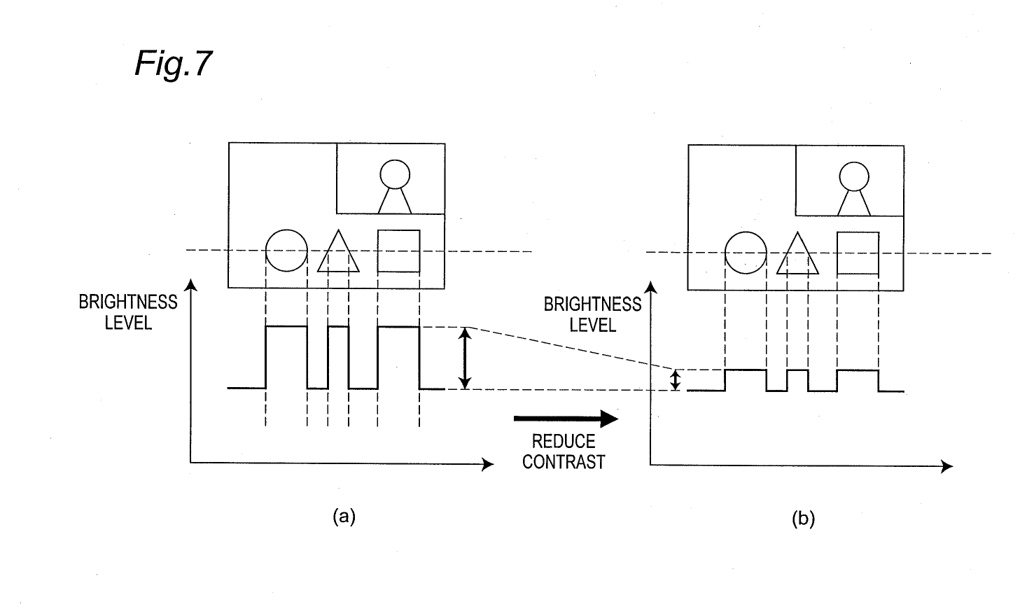

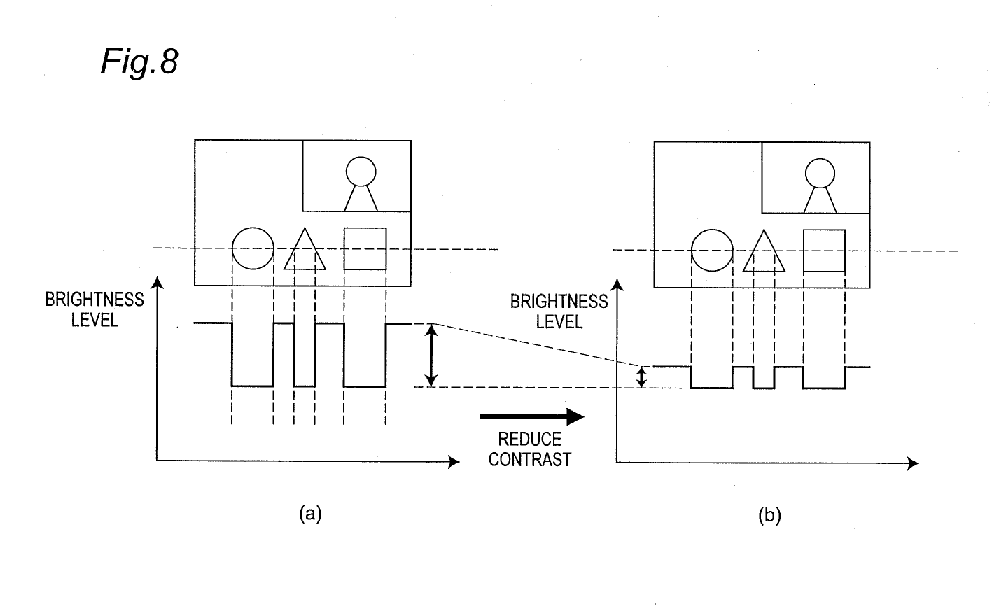

As shown in FIG. 7 and FIG. 8, the contrast between the background image and the fixed image (that is, the brightness difference) may be reduced instead of reducing the brightness when the screen saver is displayed. FIG. 7 shows an example in which the brightness of the fixed image is higher than the brightness of the background image, and FIG. 8 shows an example in which the brightness of the fixed image is lower than the brightness of the background image.

Note that it is also possible to simultaneously reduce both the brightness and the contrast when the screen saver is displayed.

As described above, this first embodiment of the invention executes steps such as described below. First, it determines if the OSD operating state, in which a fixed image of text and/or graphic elements is displayed on screen, is active. Second, it determines if there was any key input within the predetermined period T2 while in the OSD operating state. Third, if there was no key input, the screen saver operation is made active by reducing the brightness or contrast of the non-superimposed still information containing a background image and a fixed image a predetermined amount (more specifically, by changing the non-superimposed still information). This effectively prevents image burn-in from the OSD operating state.

Note that the configuration used for key input is not limited to a remote control device, and may be an operating button on the television to set-top box, or a keyboard connected to the television or set-top box.

### Embodiment 2

A second embodiment of the invention is described next with particular attention to how the second embodiment differs from the first embodiment. The screen saver display in the second embodiment of the invention causes the still image containing text or graphic elements (that is, the non-superimposed still information) to move bidirectionally both horizontally and vertically. Other aspects of the configuration, operation, and effect of this embodiment are the same as the first embodiment.

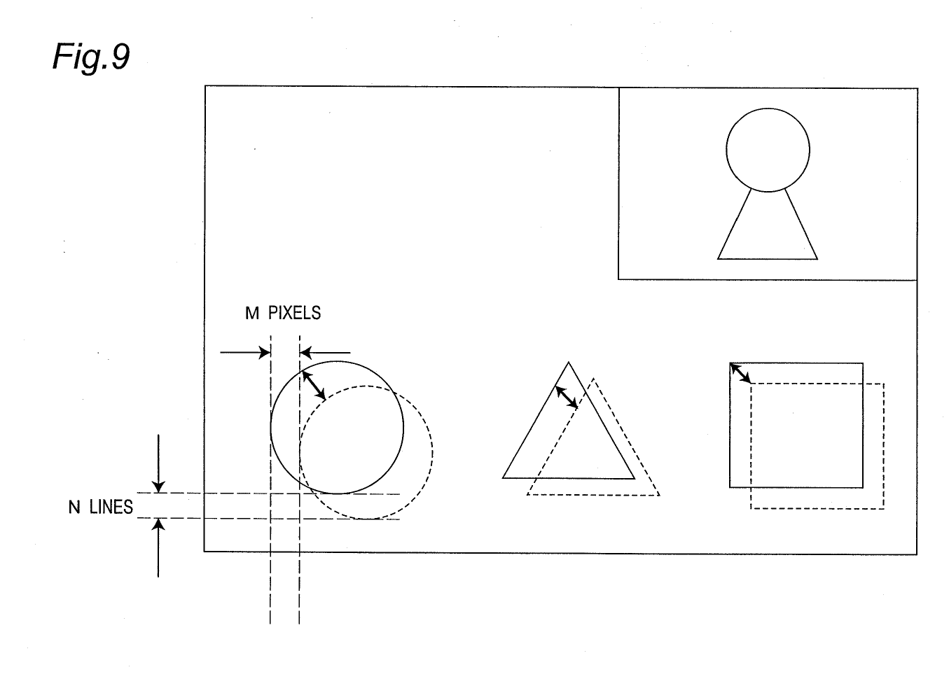

FIG. 9 shows the operation of the screen saver in the second embodiment of the invention. In FIG. 9 the still image (that is, the circle) is moved bidirectionally only M pixels horizontally (where M is an integer of 1 or more) and N lines (where N is an integer of 1 or more) vertically during the predetermined period T2. As a result, the image does not remain in a fixed location on screen. Other graphics and text can also be moved bidirectionally in the same way. Moving the still image is done by the synthesis unit 12 in FIG. 1.

The screen saver operation in this second embodiment of the invention thus causes the still image to move bidirectionally within the OSD area (that is, changes the non-superimposed still information). This effectively prevents image burn-in from the OSD area.

### Embodiment 3

A third embodiment of the invention is described next with particular attention to how the third embodiment differs from the first and second embodiments. The screen saver operation in the third embodiment of the invention extracts the horizontal border portion of the still image containing text or graphic elements (that is, the non-superimposed still information) and the background image, and causes this extracted border portion to move bidirectionally horizontally.

Other aspects of the configuration, operation, and effect of this embodiment are the same as the first and second embodiments.

While not shown in the figures, one arrangement of extracting this horizontal border portion is to apply a high pass filter operation horizontally to the pixel data on screen. An example of this high pass filter is the operation shown in equation 1 below.

Yn=ABS(Xn+1−Xn) (1)

where ABS( ) is a function that returns the absolute value, Xn denotes the pixel brightness component, and n denotes the denotes the horizontal position of the sampled pixel. Note that n denotes the sampling point one sampling period earlier than the sample at n+1. Yn denotes the absolute value of the slope of the brightness components of two horizontally adjacent pixels. If Yn is greater than or equal to a predetermined value, the two pixels are determined to indicate a border between the still image and background image. The border between the still image and background image can be accurately extracted by adjusting the magnitude of this predetermined value. A plurality of such border parts are normally extracted along a single horizontal line of the OSD area. The horizontal border parts thus extracted are caused to move bidirectionally M pixels horizontally (where M is an integer of 1 or more) during the predetermined period T2. This prevents the image from remaining in a constant location on screen.

The vertical border parts are similarly extracted by applying a high pass filtering operation to the brightness components of the pixels in the vertical direction. The extracted vertical border parts are caused to move bidirectionally N pixels vertically (where N is an integer of 1 or more) during the predetermined period T2. This prevents the image from remaining in a constant location on screen.

In other words, the screen saver operates by causing the high frequency components in a specific direction of the still image (non-superimposed still information) to move bidirectionally in this specific direction.

Note that the high pass filtering operation is applied to groups of two adjacent pixels above, but the operation can be applied using groups of three or more pixels.

As described above, the screen saver operation in the third embodiment of the invention extracts the border between the still image and background image, and causes the extracted border parts to move bidirectionally horizontally or vertically during the predetermined period T2 (that is, changes the non-superimposed still information). This effectively prevents image burn-in from the OSD area.

### Embodiment 4

A fourth embodiment of the invention is described next with particular attention to how it differs from the first to third embodiments described above. The screen saver operation in this fourth embodiment of the invention differs from the first embodiment in the configuration for starting the screen saver operation.

Other aspects of the configuration, operation, and effect of this embodiment are the same as the first to third embodiments.

The first embodiment goes from the OSD not-operating state in which video is displayed using the entire screen to the OSD operating state in which a still image containing text or graphic elements is displayed on screen when a key is pressed on a remote control, for example.

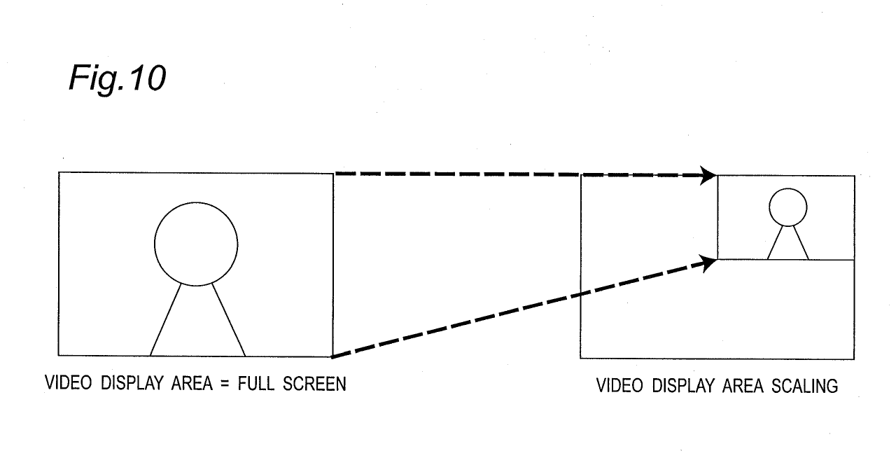

In this fourth embodiment, however, scaling (reducing) the video as shown in FIG. 10 is equivalent to the foregoing state in which the non-superimposed still information is displayed. In other words, scaling the video is treated as entering the OSD operating state. Once the OSD operating state is entered, the screen saver operation starts when the predetermined period T2 has passed as described in the first embodiment.

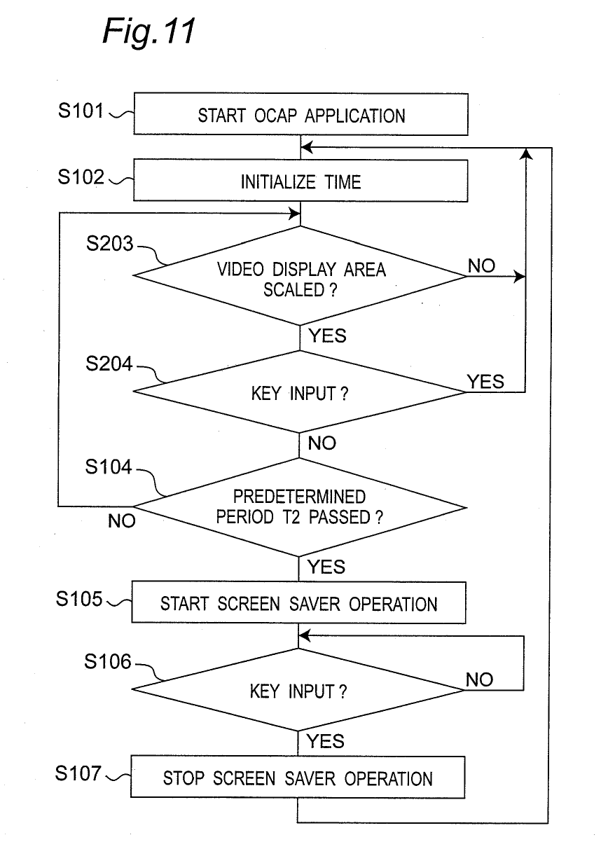

FIG. 11 shows the flow of the screen saver operation in the fourth embodiment of the invention. The flow of operation of the fourth embodiment shown in FIG. 11 differs from the flow of the first embodiment shown in FIG. 4 in that step S103 is replaced by step S203. Operation of the fourth embodiment therefore focuses on this step S203, and further description of the other steps S101, S102, S204, and S104 to S107 is omitted because they are the same as in the first embodiment. The no-screen-saver idling state and the screen saver idling state are also the same as in the first embodiment, and further description thereof is thus omitted below.

Step S203 determines that the OSD operating state is active if the video display area has been scaled. The plane management unit 13 detects scaling of the video display area. The configuration and operation whereby scaling the video display area is detected are described in detail next.

In step S203 the plane management unit 13 determines if the video display area has been scaled. If the video display area was scaled, control goes to step S204. If the video display area was not scaled, control returns to step S102.

Scaling the video display area is described in detail next.

When triggered by some event, the OCAP application 52a, 52b executes at least one of the operations of reducing the video display area or moving the video display area by the OCAP application management unit 54 and synthesis unit 12. Such triggers include user input from the remote control, timer events, and the OCAP application management unit 54 calling the startXlet method when an OCAP application 52a, 52b starts.

As in the second and third embodiments, the configuration for preventing image burn-in may move the still image itself or the border between the still image and background image horizontally or vertically.

The fourth embodiment of the invention thus starts the screen saver operation by treating scaling the video display area as entering the OSD operating state. This effectively prevents image burn-in from the OSD operating state.

### Embodiment 5

A fifth embodiment of the invention is described next with particular attention to how the fifth embodiment differs from the first to fourth embodiments. Other aspects of the configuration, operation, and effect of this embodiment are the same as the first to fourth embodiments.

The screen saver operation in this fifth embodiment of the invention differs from the first embodiment in the configuration for starting the screen saver operation.

The first embodiment goes from the OSD not-operating state in which video is displayed using the entire screen to the OSD operating state in which a still image containing text or graphic elements is displayed on screen when a key is pressed on a remote control, for example, and starts the screen saver operation when the predetermined period T2 has passed. The fifth embodiment of the invention, however, displays the screen saver if no key input is detected within the predetermined period T2 whether the OSD not-operating state or the OSD operating state is active.

The screen saver is created on the OSD plane by the synthesis unit 12. However, because the screen saver is not created by the synthesis unit 12 in the OSD not-operating state, non-superimposed still information is not displayed on the screen and only the video is displayed using the entire screen. Starting the screen saver operation in the OSD not-operating state therefore produces no apparent change because the screen saver is not displayed.

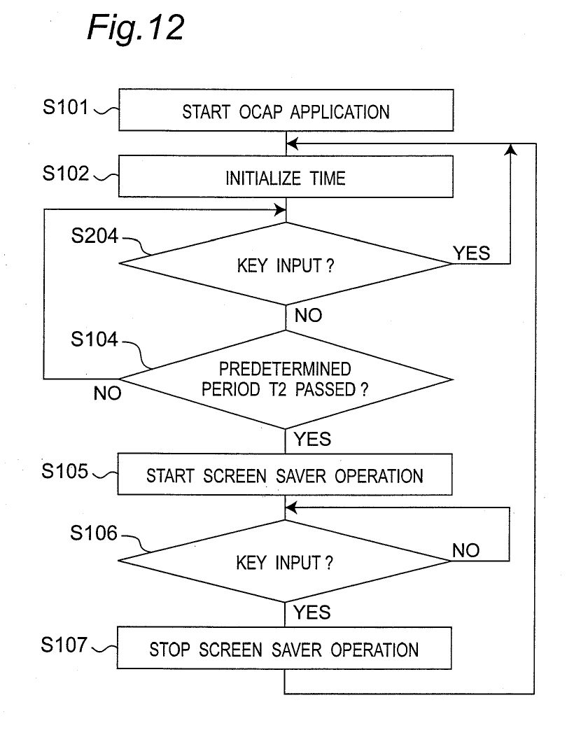

FIG. 12 shows the flow of the screen saver operation in the fifth embodiment of the invention. The flow of operation of the fifth embodiment shown in FIG. 12 differs from the flow of the first embodiment shown in FIG. 4 in that step S103, the step of determining whether the OSD operating state is active, is omitted as the step before starting the screen saver operation. The other steps S101, S102, S204, and S104 to S107 are the same as in the first embodiment. The no-screen-saver idling state and the screen saver idling state are also the same as in the first embodiment.

As in the second and third embodiments, the configuration for preventing image burn-in may move the still image itself or the border between the still image and background image horizontally or vertically.

The fifth embodiment of the invention thus starts the screen saver operation if there is no key input within the predetermined period T2 whether the state before the screen saver operation starts is the OSD not-operating state or the OSD operating state. This effectively prevents image burn-in from the OSD operating state.

### Embodiment 6

A sixth embodiment of the invention is described next with particular attention to how the sixth embodiment differs from the first to fifth embodiments. This sixth embodiment relates to a screen saver for a menu window that is displayed at a fixed position on screen when the video is displayed using the full screen. This menu window is generated by the synthesis unit 12 on the OSD plane and is displayed on the display 11.

Other aspects of the configuration, operation, and effect of this embodiment are the same as the first to fifth embodiments.

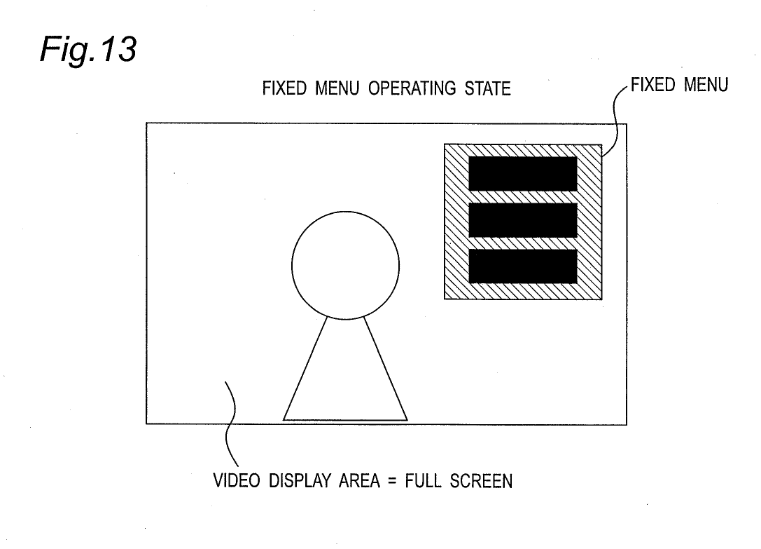

As shown in FIG. 13, the display position of the menu window is generally fixed on screen. A menu window that is displayed in a fixed position is called a “fixed menu,” and the state in which a fixed menu is displayed (the state when the fixed menu is operating) is called a “fixed menu operating state.”

The fixed menu enables, for example, adjusting the brightness and contrast settings of the television screen (display 11 or an external display), and adjusting the volume or reception channel of the cable receiver 100. The fixed menu is drawn by the plane management unit 13 on the OSD plane and output to the synthesis unit 12, and is combined with the video plane containing the video display area by the synthesis unit 12 and displayed on the display 11.

In addition to the non-superimposed still information described above in the first embodiment (referred to below as “second still information”), the still information also includes superimposed still information such as the fixed menu (referred to below as “first still information”).

In the OSD not-operating state, that is, when the video display area occupies the entire screen, the superimposed still information is displayed superimposed on the video display area in response to a command from the remote control 400, for example. This superimposed still information is a still image that may contain text and graphic elements and is displayed at a fixed size and position on screen. While the non-superimposed still information is primarily information that is used by an OCAP application and relates to the video content, the superimposed still information is information such as a set-up menu that is displayed in response to a user request. The state when the superimposed still information is displayed (the state when the superimposed still information is operating) is called the “superimposed still information operating state.” The fixed menu operating state is one example of a superimposed still information operating state.

Because the display position is always the same, a problem with displaying a fixed menu is that image burn-in occurs more easily than when an image containing text or graphic elements as described in the first embodiment is displayed.

To address this problem, the sixth embodiment of the invention starts the screen saver for the fixed menu in about half the period as the predetermined period T2 used to start the screen saver operation for the still image containing text or graphic elements in the first embodiment. Note that this half period is used by way of example only, and the period, at the end of which the screen saver starts for the fixed menu, only needs to be shorter than the predetermined period T2 described in the first embodiment.

A configuration for determining whether superimposed still information such as a fixed menu or non-superimposed still information such as a still image containing text or graphic elements is displayed as the still information is described next.

The OCAP application management unit 54 cannot directly determine whether superimposed still information is displayed or non-superimposed still information is displayed. This is because an application programming interface (API) enabling this determination is not available for OCAP applications.

A condition for displaying the superimposed still information is that the video is not scaled and is displayed using the entire screen.

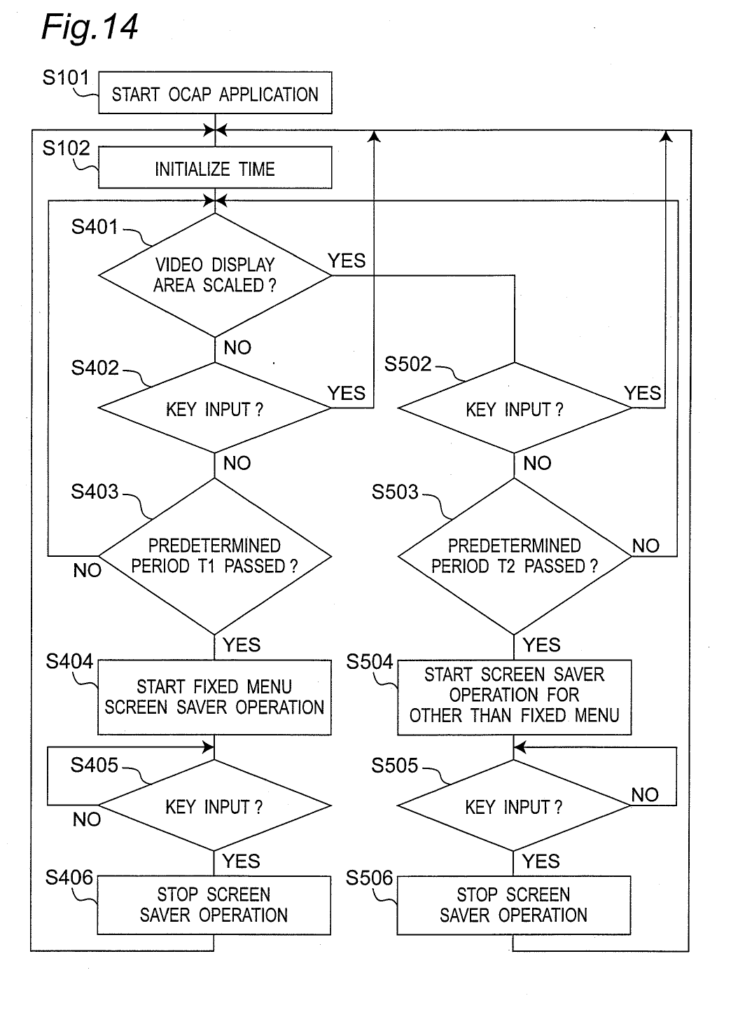

FIG. 14 shows the flow of the screen saver operation in the sixth embodiment of the invention. The flow of this operation is described below in detail by comparison with the fourth embodiment shown in FIG. 11. Description of steps S101 and S102 is omitted because they are the same as in the fourth embodiment.

As in step S203 in FIG. 11, in step S401 the plane management unit 13 detects scaling of the video display area, that is, whether the display is in the OSD operating state or the OSD not-operating state. If the video display area is scaled, the display is in the OSD operating state, control goes to step S502, and the screen saver operation for a still image other than a fixed menu (that is, for non-superimposed still information) executes (steps S502 to S506 on the right side in FIG. 14). If the video display area is not scaled, the display is in the OSD not-operating state, control goes to step S402, and the screen saver operation for a fixed menu (superimposed still information) executes (steps S402 to S406 on the left side in FIG. 14).

The flow of the screen saver operation for a fixed menu (superimposed still information) is described next.

In step S402, which corresponds to step S204 in FIG. 11, the OCAP application management unit 54 determines if there is any key input from the remote control 400. If there is no key input, control goes to step S403. If key input is detected, control returns to step S102.

In step S402, which corresponds to step S104 in FIG. 11, the OCAP application management unit 54 determines by the operating system 62 if a predetermined period T1 has passed without the video display area being scaled. If this predetermined period T1 has passed, control goes to step S404 to start the screen saver operation for a fixed menu (superimposed still information). If predetermined period T1 has not passed, control returns to step S401.

This predetermined period T1 is shorter than the predetermined period T2 until the start of the screen saver operation for a still image (non-superimposed still information) other than a fixed menu. In this embodiment of the invention T1=T2/2, for example.

In step S404, which corresponds to step S105 in FIG. 11, the OCAP application management unit 54 activates the screen saver processing unit 63 to start the screen saver operation for a fixed menu and thus enter the screen saver operating state.

In step S405, which corresponds to step S106 in FIG. 11, the OCAP application management unit 54 determines if there is any key input from the remote control 400. If key input is not detected, step S405 repeats and the screen saver operation continues. If key input is detected, control goes to step S406.

In step S406, which corresponds to step S107 in FIG. 11, the OCAP application management unit 54 stops operation of the screen saver processing unit 63, which is in the screen saver operating mode, to stop the screen saver operation for the fixed menu (superimposed still information), and control returns to step S102.

The flow (steps S502 to S506) related to the screen saver operation for a still image (non-superimposed still information) other than a fixed menu differs from the flow (steps S402 to S406) of the screen saver operation for a fixed menu (superimposed still information) in three ways.

First, the predetermined period T1 until the start of the screen saver operation in step S403 differs from the predetermined period T2 until the start of the screen saver operation in step S503.

Second, the screen saver operation that is started in step S404 is for a fixed menu (superimposed still information), whereas the screen saver operation that is started in step S504 is for a still image (non-superimposed still information) other than a fixed menu.

Third, step S406 stops the screen saver operation for a fixed menu (superimposed still information) whereas step S506 stops the screen saver operation for a still image (non-superimposed still information) other than a fixed menu.

As in the first embodiment, the state in which operation idles repeating steps S401, S402, and S403, and the state in which operation idles repeating steps S401, S502, and S503, are both called an “no-screen-saver idling state.”

In addition, the state in which operation idles repeating step S405, and the state in which operation idles repeating step S505, are both called a “screen saver idling state.”

If an interrupt signal is asserted (that is, key input is detected) while in the no-screen-saver idling state or the screen saver idling state, the OCAP application management unit 54 stops the idle state. The OCAP application management unit 54 then initializes the time in step S102, and enters the screen saver operating state when step S403 determines that the predetermined period T1 has passed since a time related to generating the interrupt signal, or when step S503 determines that the predetermined period T2 has passed since a time related to generating the interrupt signal.

The flow of operation shown in FIG. 14 is described from a different perspective below.

When neither a fixed menu (superimposed still information) or a still image other than a fixed menu (non-superimposed still information) is displayed, step S401 determines the OSD not-operating state is active and control goes to steps S402 to S406 on the left side in FIG. 14. If predetermined period T1 has not passed, the no-screen-saver idling state is active. If predetermined period T1 has passed, the screen-saver operating state is active. As described in the fifth embodiment above, because the fixed menu (superimposed still information) is not displayed in this case, the screen saver will not be displayed on screen even if the screen saver operating state is activated, and the screen saver operating state is therefore effectively not active. If the remote control 400 is operated in this state (that is, an interrupt signal is asserted) to display the fixed menu (superimposed still information) and the fixed menu (superimposed still information) becomes usable, the OCAP application management unit 54 initializes the time in step S102 and enters the no-screen-saver idling state (in this case the fixed menu operating state). The screen saver operating state for a fixed menu (superimposed still information) is then actually entered when the predetermined period T1 since a time related to generating the interrupt signal passes in step S403.

The screen saver for a fixed menu (superimposed still information) in step S404 renders the superimposed still information translucent.

Translucent as used herein means that a predetermined percentage of transparency is applied to the superimposed still information. This percentage of transparency may be any percentage greater than or equal to 0.

Because the screen area that is hidden by the superimposed still information is the video, the function of a screen saver can be rendered by making the superimposed still information translucent. It will also be obvious that the method of the screen savers described in embodiments 1 to 3 above, that is, reducing the brightness, reducing the contrast, moving the still image, or moving the border parts of the still image, may be applied to the fixed menu or other superimposed still information. A screen saver that renders the non-superimposed still information translucent may also be applied to the first to fifth embodiments described above, and this translucent screen saver may also be used simultaneously in combination with the foregoing screen saver methods of reducing the brightness, reducing the contrast, moving the still image, or moving the border parts of the still image. In other words, the OCAP application management unit 54 applies a screen saver operation that changes the superimposed still information or the non-superimposed still information.

As described above, when a fixed menu that cannot be recognized by the API of the OCAP application is displayed while video is displayed occupying the entire screen area, this sixth embodiment of the invention starts applying a screen saver operation to the fixed menu. The predetermined period T1 until the screen saver operation for the fixed menu (superimposed still information) starts is shorter than the predetermined period T2 until the screen saver operation for a still image (non-superimposed still information) other than a fixed menu starts. As a result, burn-in or image retention of a fixed menu window that is always displayed at a fixed location can be effectively prevented.

### Embodiment 7

A seventh embodiment of the invention is described next with particular attention to how the seventh embodiment differs from the first to sixth embodiments.

The seventh embodiment of the invention relates to a screen saver for an error message panel that is displayed when an error in the stream data received from the tuner 16 prevents decoding the stream data. This error message panel is referred to below as an “error panel” (that is, one type of superimposed still information).

Other aspects of the configuration, operation, and effect of this embodiment are the same as the first to sixth embodiments.

A stream data error can occur when the Program Specific Information (PSI) for channel selection cannot be correctly acquired, and when decoding fails because of scrambled data in the Elementary Stream (ES), for example. The PSI is described in the MPEG System specification (ISO/IEC 13818-1) and further description thereof is thus omitted here. The TD decoder 15 or AV decoder 14 generates and sends error information indicating that an error occurred based on the error status of the video information to the CPU 10 (note that the path from the AV decoder 14 to the CPU 10 is not shown in FIG. 1). This error information is one type of interrupt signal.

When an error such as described above is detected, an error message such as “Decode Error” is displayed in the error panel in this example. Note that the error panel can display a different message, and different messages may be displayed based on the cause of the error.

The error panel is displayed when an error occurs and is erased when the cause of the error is resolved. Errors are reported by the device driver and library related to the hardware that decodes the stream, for example. An OCAP application supports an error detection and reporting API, and can thus know when an error occurs and the cause of the error.

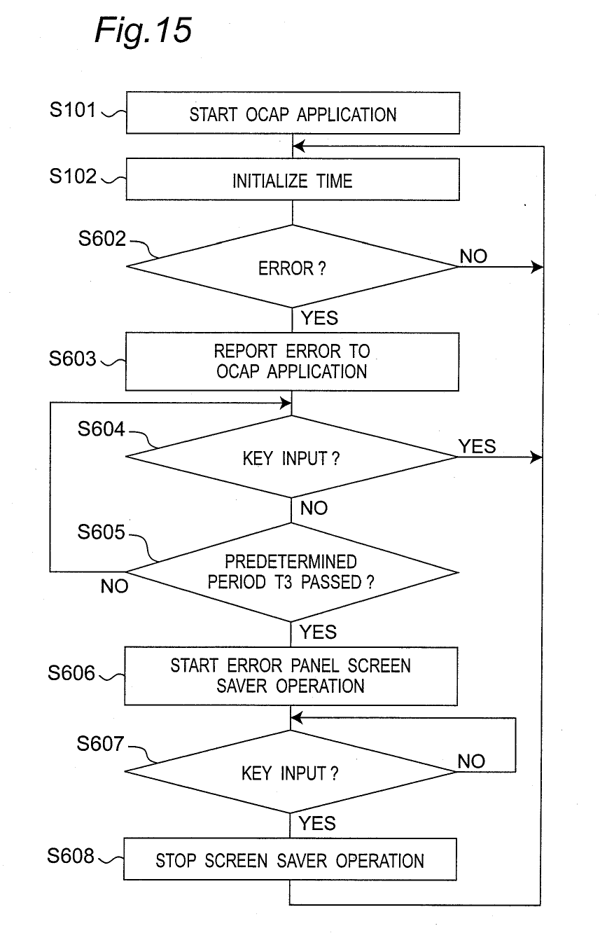

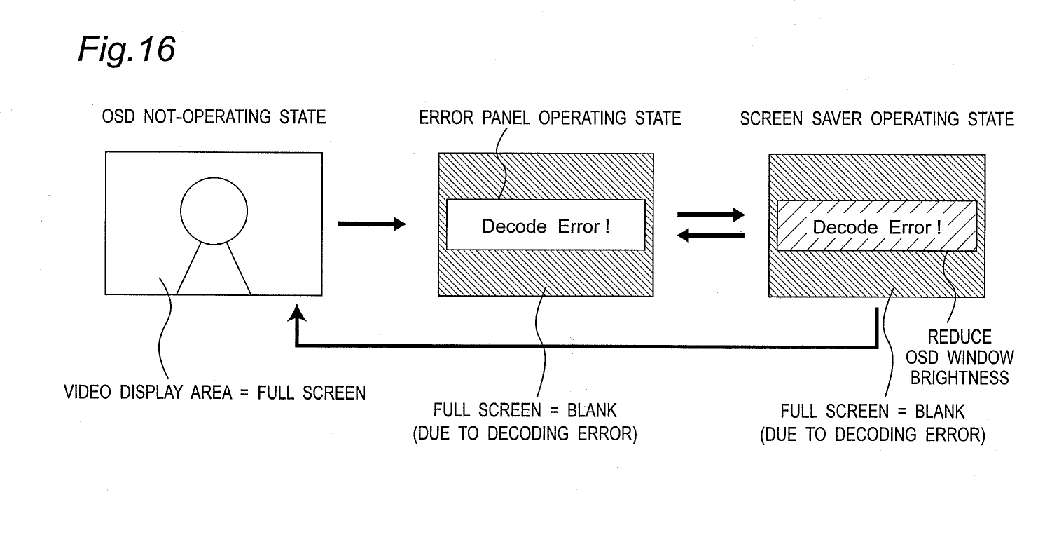

FIG. 15 shows the flow of the screen saver operation in the seventh embodiment of the invention. FIG. 16 illustrates the change in the display.

The video display area occupies the entire screen and the display is in the OSD not-operating state in the example shown on the left side in FIG. 16.

In the display shown in the middle, a decoding error has occurred, the video cannot be decoded, and the entire screen is blank except for the error panel with the message “Decode Error” that is displayed in the center of the screen. This is called the “error panel operating state,” which is one superimposed still information operating state.

The display shown on the right in FIG. 16 is in the screen saver operating state and the brightness of the error panel shown in the middle display is reduced. When the cause of the error is eliminated, the display returns to the state shown on the left side.

The flow of operation shown in FIG. 15 is described in detail below.

Steps S101 and S102 are the same as in the first embodiment shown in FIG. 4.

In step S602 the OCAP application management unit 54 determines if there are any errors that have not been reported to the OCAP application 52a, 52b in the stream data received from the tuner 16. If an error is detected, control goes to step S603. If an error is not detected, control returns to step S102.

In step S603 the OCAP application management unit 54 reports the error to the OCAP application 52a, 52b and enters the error panel operating state.

In step S604, which corresponds to step S204 in FIG. 4, the OCAP application management unit 54 determines if there is any key input from the remote control 400. If key input is detected, control returns to step S102. If there is no key input, control goes to step S605.

In step S605, which corresponds to step S104 in FIG. 4, the OCAP application management unit 54 determines by the operating system 62 if a predetermined period T3 has passed. If this predetermined period T3 has passed, control goes to step S606. If predetermined period T3 has not passed, control returns to step S604.

In step S606, which corresponds to step S105 in FIG. 4, the OCAP application management unit 54 activates the screen saver processing unit 63 to start the screen saver operation for an error panel and thus enter the screen saver operating state.

In step S607, which corresponds to step S106 in FIG. 4, the OCAP application management unit 54 determines if there is any key input from the remote control 400. If key input is detected, control goes to step S608. If key input is not detected, step S607 repeats and the screen saver operation continues.

In step S608, which corresponds to step S107 in FIG. 4, the OCAP application management unit 54 stops the operation of the screen saver processing unit 63 which was started in step S606 to stop the screen saver operation, and control returns to step 3102.

Because an error panel is displayed at a fixed position similarly to the stationary panel in the sixth embodiment, the predetermined period T3 until the screen saver operation starts is effective if set shorter than the predetermined period T2 until the still image screen saver operation starts in the first to fifth embodiments.

The flow of operation shown in FIG. 15 is applied next to the sixth embodiment described above with reference to FIG. 14.

The determination related to error detection in step S602 in FIG. 15 occurs simultaneously to the detection of key input in steps S402 and S405 in FIG. 14. The fixed menu operating state is entered if key input is detected in the determination related to key input, and the error panel operating state is entered if an error is detected in the error detection process. The determination related to the predetermined period T1 in step S403 in FIG. 14 is made at the predetermined period. T3 if in the error panel operating state. The start of the screen saver operation in step S404 in FIG. 14 starts the error panel screen saver operation if the error panel operating state is active.

In FIG. 14, if an interrupt signal is asserted (that is, an error occurs) while in the no-screen-saver idling state or the screen saver idling state, the OCAP application management unit 54 stops the idle state. The OCAP application management unit 54 then initializes the time in step S102, and enters the no-screen-saver idling state (in this case the error panel operating state). When the predetermined period T3 since a time related to generating the interrupt signal passes in step S403, the OCAP application management unit 54 enters the screen saver operating state for the error panel (superimposed still information).

The error panel screen saver that starts in step S606 may render the superimposed still information in the error panel translucent as in the sixth embodiment, or may use any of the screen saver methods of reducing the brightness, reducing the contrast, moving the still image, or moving the border parts of the still image, for example, described in the first to third embodiments.

The screen saver methods of reducing the brightness, reducing the contrast, moving the still image, or moving the border parts of the still image, for example, are preferred when an error is displayed on a blank screen with no video content output.

As described above, for an error panel that is displayed when an error occurs in the stream data received from the tuner 16 and the stream data cannot be decoded, this seventh embodiment of the invention starts the screen saver operation when the error continues for at least a predetermined period T3. This effectively prevents burn-in by the error panel.

### Embodiment 8

An eighth embodiment of the invention is described next with particular attention to how the eighth embodiment differs from the first to seventh embodiments.

The eighth embodiment relates to a screen saver for a man-machine interface (MMI) panel that is a graphical user for interface displaying information from a cable card 300 when a cable card 300 that has not been activated (authorized) is used in a television that conforms to the OCAP specification (an “OCAP-TV” below).

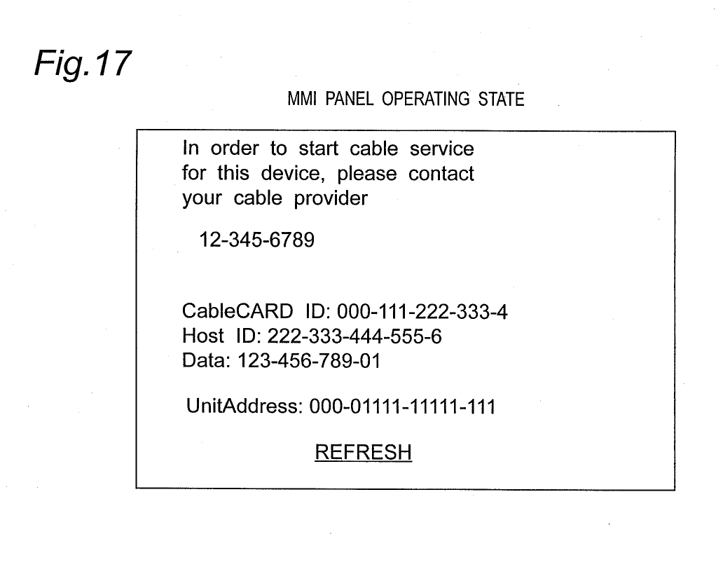

The cable card interface 17 receives and sends card information from the cable card 300 to the CPU 10. If the cable card 300 has not been activated, such as when the user has not completed a subscriber contract with the provider, card information is presented in the MMI panel. The card information includes an interrupt signal. FIG. 17 shows an example of the MMI panel display content. If the cable card 300 is not enabled, the MMI panel (that is, a type of superimposed still information) is displayed occupying the entire screen, prompting the user to complete a service contract.

The state in which the MMI panel is displayed is called a “MMI panel operating state,” which is a superimposed still information operating state.

Other aspects of the configuration, operation, and effect of this embodiment are the same as the first to seventh embodiments.

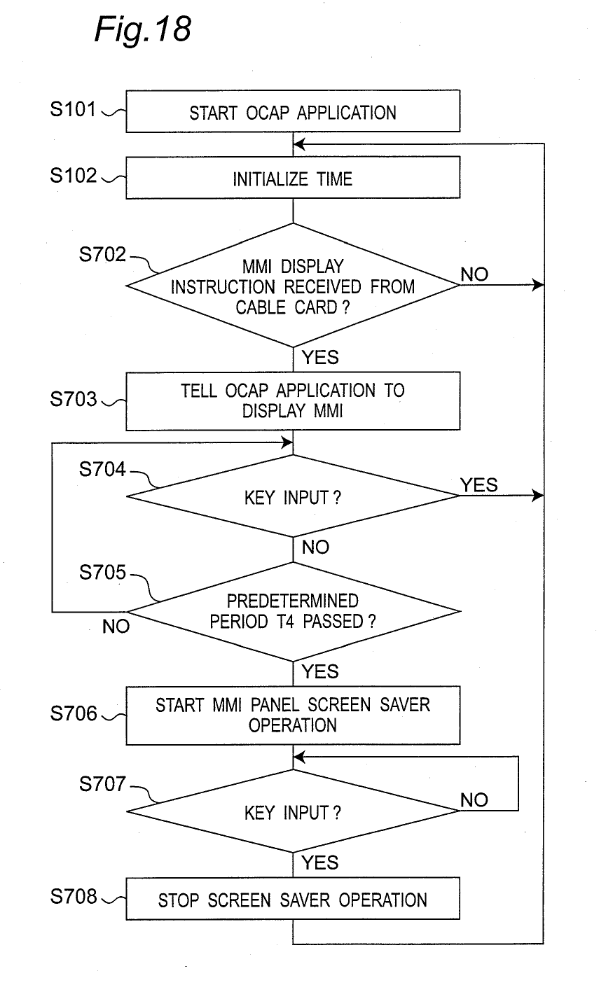

FIG. 18 shows the flow of the screen saver operation in the eighth embodiment of the invention. The flow of this operation is described next in detail.

Steps S101 and S102 are the same as in the first embodiment.

In step S702 the OCAP application management unit 54 determines if displaying the man-machine interface is indicated by the cable card 300. If displaying the man-machine interface is indicated, control goes to step S703. If displaying the MMI panel is not indicated, control returns to step S102.

In step S703 the OCAP application management unit 54 instructs the OCAP application 52a, 52b to display the MMI panel and enters the MMI panel operating state.

In step S704, which corresponds to step S204 in FIG. 4, the OCAP application management unit 54 determines if there is any key input from the remote control 400. If key input is detected, control returns to step S102. If there is no key input, control goes to step S705.

In step S705, which corresponds to step S104 in FIG. 4, the OCAP application management unit 54 determines by the operating system 62 if a predetermined period T4 has passed. If this predetermined period T4 has passed, control goes to step S706. If predetermined period T4 has not passed, control returns to step S704.

In step S706, which corresponds to step S105 in FIG. 4, the OCAP application management unit 54 activates the screen saver processing unit 63 to start the screen saver operation for an MMI panel and thus enter the screen saver operating state.

In step S707, which corresponds to step S106 in FIG. 4, the OCAP application management unit 54 determines if there is any key input from the remote control 400. If key input is detected, control goes to step S708. If key input is not detected, step S707 repeats and the screen saver operation continues.

In step S708, which corresponds to step S107 in FIG. 4, the OCAP application management unit 54 stops the operation of the screen saver processing unit 63 which was started in step S606 to stop the screen saver operation, and control returns to step S102.

Because a MMI panel is displayed at a fixed position similarly to the stationary panel in the sixth embodiment, the predetermined period T4 until the screen saver operation starts is effective if set shorter than the predetermined period T2 until the still image screen saver operation starts in the first to fifth embodiments.

The flow of operation shown in FIG. 18 is applied next to the sixth embodiment described above with reference to FIG. 14.

The determination related to the MMI display instruction in step S702 in FIG. 18 occurs simultaneously to the detection of key input in steps S402 and S405 in FIG. 14. The fixed menu operating state is entered if key input is detected in the determination related to key input, and the MMI panel operating state is entered if an MMI display instruction is detected in the determination related to the MMI display instruction. The determination related to the predetermined period T1 in step S403 in FIG. 14 is made at the predetermined period T3 if in the MMI panel operating state. The start of the screen saver operation in step S404 in FIG. 14 starts the MMI panel screen saver operation if the MMI panel operating state is active.

In FIG. 14, if an interrupt signal is asserted (that is, an MMI display instruction is detected) while in the no-screen-saver idling state or the screen saver idling state, the OCAP application management unit 54 stops the idle state. The OCAP application management unit 54 then initializes the time in step S102, and enters the no-screen-saver idling state (in this case the MMI panel operating state). When the predetermined period T3 since a time related to generating the interrupt signal passes in step S403, the OCAP application management unit 54 enters the screen saver operating state for the MMI panel (superimposed still information).

Note that the error panel operating state of the seventh embodiment and the MMI panel operating state of the eight embodiment can be applied simultaneously in the flow of operation shown in FIG. 14.

The MMI panel screen saver that starts in step S706 may render the superimposed still information in the error panel translucent as in the sixth embodiment, or may use any of the screen saver methods of reducing the brightness, reducing the contrast, moving the still image, or moving the border parts of the still image, for example, described in the first to third embodiments.

As described above, for an MMI panel that is displayed when an unactivated cable card 300 is used in an OCAP-TV, this eighth embodiment of the invention starts the screen saver operation when the panel is displayed for at least the predetermined period T4. This effectively prevents burn-in by the MMI panel.

### Embodiment 9

A ninth embodiment of the invention is described next with particular attention to how the ninth embodiment differs from the first to eighth embodiments.

The sixth embodiment described above relates to a screen saver that is used when a fixed menu is displayed, and this, ninth embodiment relates to a burn-in prevention method that operates when the screen saver operation stops.

Other aspects of the configuration, operation, and effect of this embodiment are the same as the first to eighth embodiments.

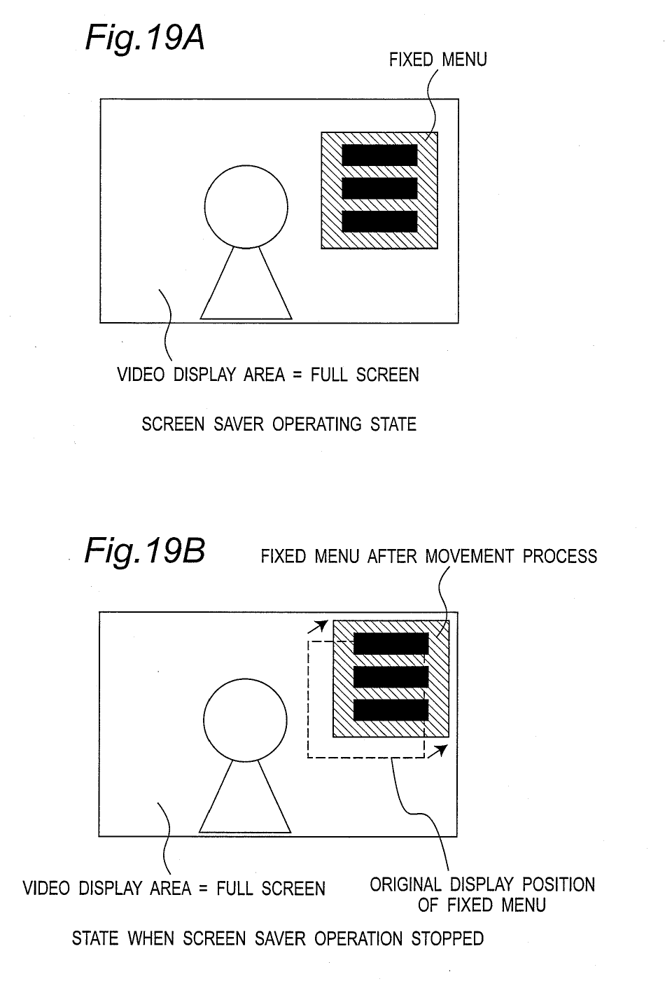

FIG. 19A and FIG. 19B describe a method of preventing burn-in when the screen saver operation stops. FIG. 19A shows the screen saver operating state, and FIG. 19B shows the display when the screen saver operation stops. A screen-saver-off movement process that moves the screen saver area for a fixed menu (superimposed still information) and the screen saver area for a still image (non-superimposed still information) other than a fixed menu a predetermined distance toward the top right corner of the display from the position before the screen saver operation starts executes in FIG. 19B. The distance moved horizontally and vertically in this screen-saver-off movement process can be set as desired, and the direction of movement in the screen-saver-off movement process can therefore be in any desired direction and is not limited to the direction toward the top right corner. The direction and distance of movement in the screen-saver-off movement process can also be changed each time the screen saver stops.

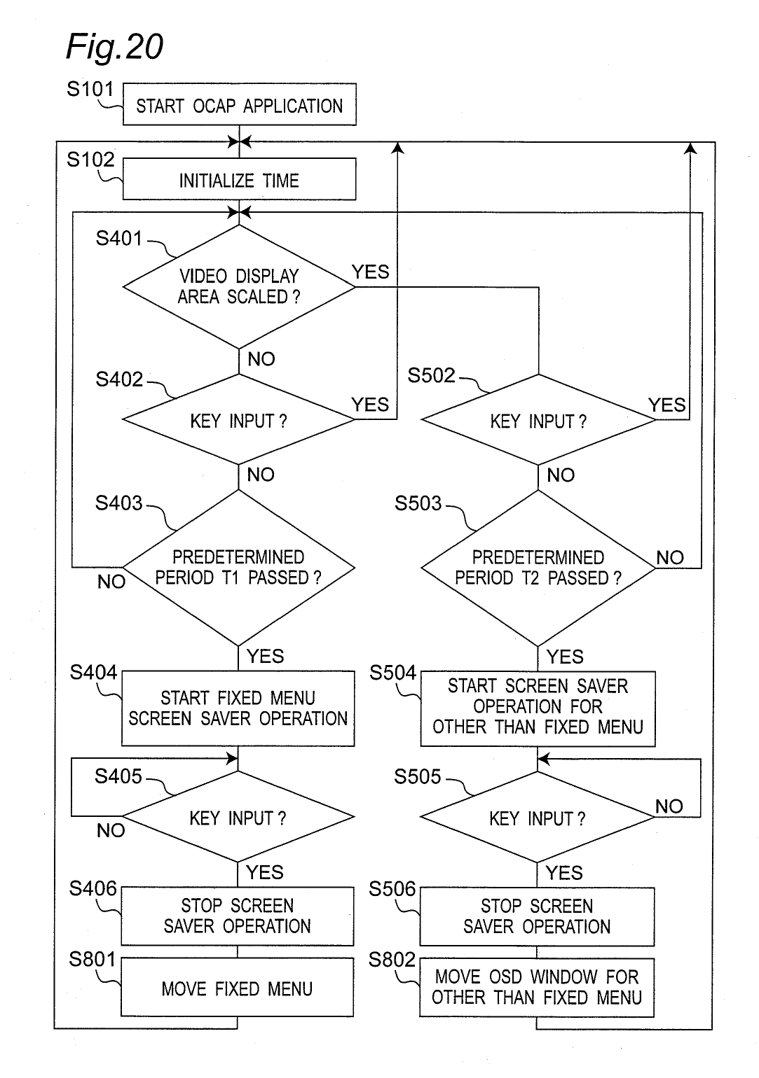

FIG. 20 shows the operation when the screen saver stops in the ninth embodiment of the invention. The flow of operation of this ninth embodiment shown in FIG. 20 differs from the flow of operation of the sixth embodiment shown in FIG. 14 in that screen-saver-off movement process steps S801 and S802 are added after screen saver operation is stopped in steps S406 and S506, respectively.

Because a fixed menu (superimposed still information) can cause burn-in more easily than a still image (non-superimposed still information) other than a fixed menu, the screen-saver-off movement process can be executed only in step S801 and step S802 can be omitted.

Note that in addition to applying the screen-saver-off movement process to the screen saver area of the fixed menu (superimposed still information) and still image (non-superimposed still information) other than a fixed menu, a process not shown that moves the video display area in the same direction and the same distance as the screen saver area can also be applied in conjunction with the process moving the screen saver area.

In addition, the screen-saver-off movement process can also be executed when screen saver operation stops in the first to fifth embodiments described above.

As described above, the ninth embodiment of the invention applies a screen-saver-off movement process to the fixed menu (superimposed still information) and still image (non-superimposed still information) other than a fixed menu when screen saver operation stops. As a result, burn-in can also be prevented after the screen saver operation stops.

### Embodiment 10

A tenth embodiment of the invention is described next with particular attention to how the tenth embodiment differs from the first to ninth embodiments.

The tenth embodiment relates to the on-screen display of an emergency message panel when an emergency alert is broadcast, and relates more particularly to not starting the screen saver operation when the emergency message panel is displayed.

The emergency warning system in the United States transmits an EAS (Emergency Alert System) signal in the MPEG-2 Section format using an Out-of-Band (OOB). The EAS signal is described in detail in the SCTE 18 standard (Society of Cable Telecommunications Engineers).

Other aspects of the configuration, operation, and effect of this embodiment are the same as the first to ninth embodiments.

When the tuner 16 of the cable receiver 100 shown in FIG. 1 receives an EAS signal, the cable card interface 17 generates an EAS signal (also called an “emergency information signal”) based on the received signal using the cable card 300, and sends the EAS signal to the CPU 10. The CPU 10 extracts the EAS signal stored in the section data, and generates an emergency message (that is, emergency information) based on the extracted EAS signal. The plane management unit 13 then superimposes the emergency message on the OSD plane, and the synthesis unit 12 merges the OSD plane with the video plane containing the video content and displays the result on the display 11. The cable card interface 17 is also called an emergency information signal generating unit when it generates the emergency information signal.

When an EAS signal is received, the tenth embodiment of the invention does not start applying the screen saver operation to the superimposed still information displaying the EAS signal message because of the importance and urgency of the information.

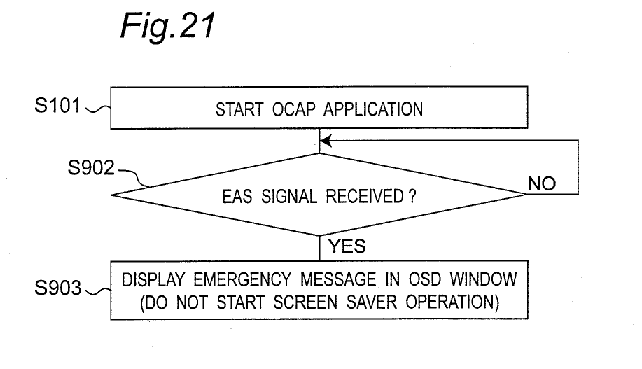

FIG. 21 shows the flow of operation when an EAS signal is received. The EAS signal is extracted after an EAS signal is received in step S902 in

FIG. 21. In step S903, the emergency message generated from the EAS signal is displayed in an OSD window, and the screen saver operation is prevented from starting in the OSD window where the emergency message based on the EAS signal is displayed.

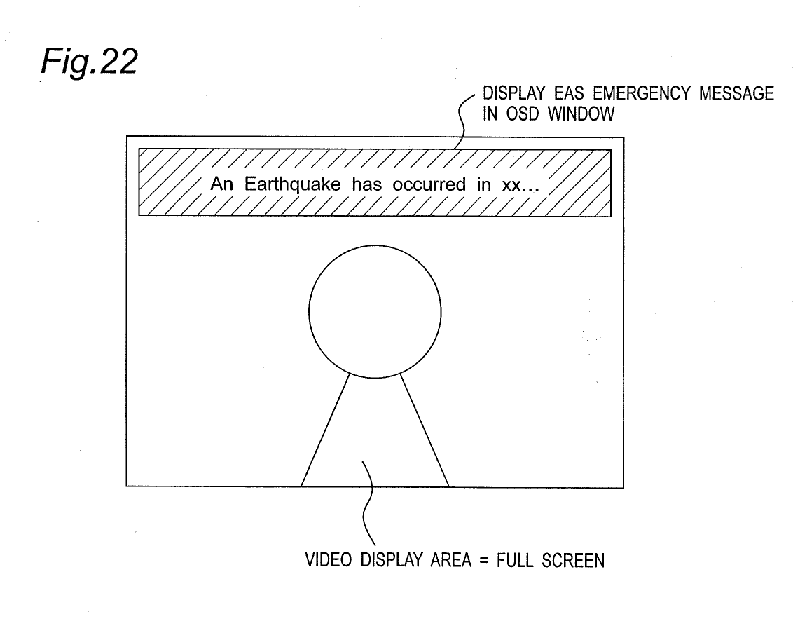

FIG. 22 shows an example of the display when the emergency message of the EAS signal is displayed. The emergency message is displayed in an OSD window at the top part of the screen, and starting the screen saver operation in this OSD window is prevented. Note that the method of displaying an emergency message is not so limited, and the emergency message may be displayed anywhere on the display.

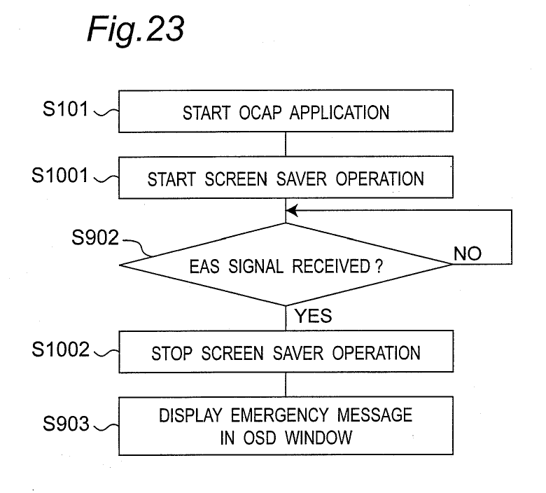

Alternatively, as shown in FIG. 23, if an EAS signal is received (step S902) in the screen saver operating state (step S1001) described in any of the foregoing embodiments, the screen saver processing unit 63 can be stopped to stop the screen saver operation (step S1002).

As described above, the tenth embodiment of the invention prevents the screen saver operation from starting when an EAS signal is received during an emergency alert broadcast and the emergency message contained in the EAS signal is displayed in an OSD window. As a result, important emergency messages can be conspicuously presented when an emergency alert signal is received.

The foregoing first to tenth embodiments are described with reference to an OCAP-TV, but the invention can also be applied to reception devices other than OCAP-TVs.

The first to tenth embodiments are also described using a plasma display panel by way of example, but the invention can also be applied to organic electroluminescent display panels and other types of display panels other than plasma display panels.

The present invention is a reception device that can receive cable broadcasts conforming to the OCAP specification, and is useful for reception devices such as televisions that display still images containing text or graphic elements on a PDP or other type of flat panel display, and to set-top boxes connected to flat panel displays such as plasma display panels.

The invention can be used in reception devices and reception methods capable of receiving cable broadcasts conforming to the OCAP specification.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A reception device that processes a reception signal and generates display information displayed on a display screen, comprising:
a display information generating unit that manages a first plane that can contain video information generated from the reception signal and a second plane that can contain first still information or second still information, generates the display information by merging the first plane and second plane, and outputs the display information to the display screen;
an interrupt signal generating unit that generates an interrupt signal; and
a control unit that controls the display information generating unit to generate and output to the display screen display information containing the first still information or second still information related to the interrupt signal in the second plane when an interrupt signal is input,
starts a screen saver operation that changes the first still information after a first predetermined period if the display area of the video information is the full display area of the display screen, and
starts a screen saver operation that changes the second still information after a second predetermined period if the display area of the video information is smaller than the full display area of the display screen.

2. The reception device described in claim 1, wherein:
the first predetermined period is shorter than the second predetermined period.

3. The reception device described in claim 1, wherein:
the first still information is a set-up menu for at least one of the reception device or display.

4. The reception device described in claim 1, wherein:
the second still information is information related to the video information.

5. The reception device described in claim 1, wherein:
the interrupt signal generating unit generates the interrupt signal based on information from an external input unit.

6. The reception device described in claim 1, wherein:
said interrupt signal generating unit generates the interrupt signal based on a video information error state; and
said control unit generates the display information to contain error information on the second plane, outputs the display information to the display screen, and starts a screen saver operation that changes the error information after the first predetermined period.

7. The reception device described in claim 1, wherein:
said interrupt signal generating unit generates the interrupt signal based on information related to incompletion of a service contract from a cable card; and
said control unit generates the display information to contain information prompting a service contract on the second plane, outputs the display information to the display screen, and starts a screen saver operation that changes the information prompting a service contract after the first predetermined period.

8. The reception device described in claim 1, further comprising:
an emergency information signal generating unit that generates an emergency information signal based on the reception signal;
wherein said control unit generates the display information to contain emergency information on the second plane, outputs the display information to the display screen, and refrains from starting a screen saver operation even after the first predetermined period or second predetermined period has passed.

9. The reception device described in claim 1, wherein:
said control unit stops screen saver operation if an interrupt signal is generated after the screen saver operation starts.

10. The reception device described in claim 1, wherein:
said control unit moves at least one of the first still information and second still information on the screen as the screen saver operation.

11. The reception device described in claim 1, wherein:
said control unit reduces the brightness of at least one of the first still information and second still information as the screen saver operation.

12. The reception device described in claim 1, wherein:
the second plane can contain at least one of first background information representing information in the background of the first still information, and second background information representing information in the background of the second still information.

13. The reception device described in claim 12, wherein:
said control unit reduces the brightness difference between the first still information and first background information as the screen saver operation.

14. The reception device described in claim 12, wherein:
said control unit reduces the brightness difference between the second still information and second background information as the screen saver operation.

15. The reception device described in claim 1, wherein:
said control unit moves a high frequency component in a direction of at least one of the first still information or second still information as the screen saver operation.

16. The reception device described in claim 1, wherein:
said control unit applies transparency to at least one of the first still information or second still information as the screen saver operation.

17. The reception device described in claim 1, wherein:
said display information generating unit includes a plane management unit and a synthesis unit;
said plane management unit manages the first plane that can contain video information generated from the reception signal and the second plane that can contain the first still information and the second still information; and
said synthesis unit generates the display information by merging the first plane and second plane.

18. A reception method for processing a reception signal and generating display information displayed on a display screen, comprising:
managing a first plane that can contain video information generated from the reception signal and a second plane that can contain first still information or second still information, generating the display information by merging the first plane and second plane;
generating an interrupt signal; and
controlling the step of generating the display information to generate and output to the display screen display information containing the first still information or second still information related to the interrupt signal in the second plane when an interrupt signal is input,
starting a screen saver operation that changes the first still information after a first predetermined period if the display area of the video information is the full display area of the display screen, and
starting a screen saver operation that changes the second still
information after a second predetermined period if the display area of the video information is smaller than the full display area of the display screen.
